(19) United States
(12) Patent Application Publication
(10) Pub. No.: US 2023/0142712 A1
(43) Pub. Date: May 11, 2023

(54) ELECTRODE AND METHOD FOR PRODUCING ALL-SOLID-STATE BATTERY

(71) Applicant: TOYOTA JIDOSHA KABUSHIKI KAISHA, Toyota-shi (JP)

(72) Inventors: Ryuto SAKAMOTO, Okazaki-shi (JP); Nobuhiro TSUJI, Kusatsu-shi (JP); Tetsuya NAOKI, Otsu-shi (JP); Yasuo ISHII, Kusatsu-shi (JP)

(73) Assignee: TOYOTA JIDOSHA KABUSHIKI KAISHA, Toyota-shi (JP)

(21) Appl. No.: 17/979,990

(22) Filed: Nov. 3, 2022

(30) Foreign Application Priority Data
Nov. 10, 2021 (JP) 2021-182952

(51) Int. Cl. H01M 4/139; H01M 4/04

(52) U.S. Cl. CPC H01M 4/139; H01M 4/04

(57) ABSTRACT

An electrode for all-solid-state batteries, the electrode comprising a collector and an electrode layer, wherein a contact surface of the collector with the electrode layer and a contact surface of the electrode layer with the collector, are attached by an adhesive layer; wherein the adhesive layer is composed of adhesive lines disposed in stripes between the contact surfaces; wherein a ratio (B/A) of a width B (mm) of the applied adhesive lines to an electrical conductivity A (mS) of the electrode layer, is 75.00 or less; wherein a distance C (mm) between the adjacent adhesive lines is more than 0.2 mm and is 7 mm or less; and wherein a ratio (B/C) of the width B of the applied adhesive lines to the distance C between the adjacent adhesive lines, is 2.00 or less.

### TECHNICAL FIELD

The disclosure relates to an electrode and a method for producing an all-solid-state battery.

### BACKGROUND

An all-solid-state battery has drawn attention in that it uses a solid electrolyte as the electrolyte disposed between the cathode and the anode, instead of a liquid electrolyte containing an organic solvent.

Patent Literature 1 discloses an all-solid-state battery including an attaching means for attaching a collector to a battery unit stacked adjacently to the collector.

Patent Literature 1: Japanese Patent Application Laid-Open (JP-A) No. 2017-204377

There is a demand for reducing the resistance of an all-solid-state battery. In Patent Literature 1, a hot-melt agent is used as an attaching means and disposed in the shape of the letter “L” at the corners of the battery unit. Since the area of the hot-melt agent disposed on the battery unit is small, the resistance of an all-solid-state battery increases.

### SUMMARY

The present disclosure was achieved in light of the above circumstances. An object of the present disclosure is to provide an electrode configured to reduce the resistance of an all-solid-state battery, and a method for producing an all-solid-state battery.

The electrode of the present disclosure is an electrode for all-solid-state batteries, the electrode comprising a collector and an electrode layer,
wherein a contact surface of the collector with the electrode layer and a contact surface of the electrode layer with the collector, are attached by an adhesive layer;
wherein the adhesive layer is composed of adhesive lines disposed in stripes between the contact surfaces;
wherein a ratio (B/A) of a width B (mm) of the applied adhesive lines to an electrical conductivity A (mS) of the electrode layer, is 75.00 or less;
wherein a distance C (mm) between the adjacent adhesive lines is more than 0.2 mm and is 7 mm or less; and
wherein a ratio (B/C) of the width B of the applied adhesive lines to the distance C between the adjacent adhesive lines, is 2.00 or less.

The all-solid-state battery production method of the present disclosure is a method for producing an all-solid-state battery in which a first electrode layer, a solid electrolyte layer and a second electrode layer are disposed in this order; a first collector and the first electrode layer are attached by an adhesive layer; and the second electrode layer and a second collector are attached by an adhesive layer,
the method comprising:
preparing a first stack in which the first electrode layer, the solid electrolyte layer and the second electrode layer are disposed in this order,
forming an adhesive layer, which is composed of adhesive lines disposed in stripes, by applying an adhesive in stripes on a surface, which is brought into contact with the first collector, of the first electrode layer or a surface, which is brought into contact with the first electrode layer, of the first collector and on a surface, which is brought into contact with the second collector, of the second electrode layer or a surface, which is brought into contact with the second electrode layer, of the second collector, and
attaching the first electrode layer and the first collector by the adhesive layer and attaching the second electrode layer and the second collector by the adhesive layer (a collector attaching step),
wherein each of a first electrode comprising the first electrode layer and the first collector and a second electrode comprising the second electrode layer and the second collector, is the electrode described above.

Another all-solid-state battery production method of the present disclosure is a method for producing an all-solid-state battery in which a first electrode layer, a solid electrolyte layer and a second electrode layer are disposed in this order on both surfaces of a first collector, and the second electrode layer and a second collector are attached by an adhesive layer,
the method comprising:
preparing a second stack in which the first electrode layer, the solid electrolyte layer and the second electrode layer are disposed in this order on both surfaces of the first collector;
forming an adhesive layer, which is composed of adhesive lines disposed in stripes, by applying an adhesive in stripes on a surface, which is brought into contact with the second collector, of the second electrode layer or a surface, which is brought into contact with the second electrode layer, of the second collector, and
attaching the second electrode layer and the second collector by the adhesive layer (a collector attaching step),
wherein a second electrode comprising the second electrode layer and the second collector is the electrode described above.

According to the present disclosure, an electrode configured to reduce the resistance of an all-solid-state battery and a method for producing an all-solid-state battery, are provided.

### BRIEF DESCRIPTION OF THE DRAWING

FIG. 1 is a schematic sectional view of an example of the electrode of the present disclosure.

### DETAILED DESCRIPTION

### 1. Electrode

The electrode of the present disclosure is an electrode for all-solid-state batteries, the electrode comprising a collector and an electrode layer,
wherein a contact surface of the collector with the electrode layer and a contact surface of the electrode layer with the collector, are attached by an adhesive layer;
wherein the adhesive layer is composed of adhesive lines disposed in stripes between the contact surfaces;
wherein a ratio (B/A) of a width B (mm) of the applied adhesive lines to an electrical conductivity A (mS) of the electrode layer, is 75.00 or less;
wherein a distance C (mm) between the adjacent adhesive lines is more than 0.2 mm and is 7 mm or less; and
wherein a ratio (B/C) of the width B of the applied adhesive lines to the distance C between the adjacent adhesive lines, is 2.00 or less.

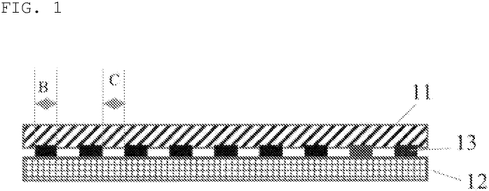

FIG. 1 is a schematic sectional view of an example of the electrode of the present disclosure.

As shown in FIG. 1, the electrode of the present disclosure includes a collector 11 and an electrode layer 12. The contact surface of the collector 11 with the electrode layer 12 and the contact surface of the electrode layer 12 with the collector 11, are attached by an adhesive layer composed of adhesive lines 13 disposed in stripes. In FIG. 1, B is the width of the adhesive lines 13, and C is the distance between the adjacent adhesive lines 13.

### Electrode

The electrode of the present disclosure includes the collector and the electrode layer.

The contact surface of the collector with the electrode layer and the contact surface of the electrode layer with the collector, are attached by the adhesive layer. More specifically, the adhesive layer is disposed between the collector and the electrode layer, and the collector and the electrode layer may be attached by the adhesive layer. The contact surface of the collector with the electrode layer and the contact surface of the electrode layer with the collector, may be the surface, which is in contact with the electrode layer, of the collector and the surface, which is in contact with the collector, of the electrode layer, respectively. The contact surface of the collector with the electrode layer may be attached to the contact surface of the electrode layer with the collector by the adhesive layer. The contact surface of the electrode layer with the collector may be attached to the contact surface of the collector with the electrode layer by the adhesive layer.

### Adhesive Layer

The adhesive layer is composed of the adhesive lines disposed in stripes between the contact surfaces. That is, the contact surface of the collector and that of the electrode layer may be partly attached by the adhesive layer, and the contact surfaces do not need to be entirely attached.

The term “in stripes” means a striped pattern. The striped pattern may be parallel stripes and may be vertical or horizontal stripes.

The number of the adhesive lines may be three or more. The upper limit is not particularly limited.

The length of the adhesive lines may be from 1 mm to 10 mm, for example.

In the electrode of the present disclosure, the ratio (B/A) of the width B (mm) of the applied adhesive lines to the electrical conductivity A (mS) of the electrode layer, may be 75.00 or less.

The distance C (mm) between the adjacent adhesive lines may be more than 0.2 mm and may be 7 mm or less. The pitch between the adhesive lines may be more than 0.2 mm and may be 7 mm or less.

The ratio (B/C) of the width B of the applied adhesive lines to the distance C between the adjacent adhesive lines, may be 2.00 or less.

The adhesive used to form the adhesive layer is not particularly limited, as long as it is a solid adhesive having adhesive function. As the type of the adhesive, examples include, but are not limited to, a tacky resin and a hot-melt agent. As the tacky resin, examples include, but are not limited to, an acrylic resin, a rubber-based resin, a silicone resin and a urethane resin. The hot-melt agent is not particularly limited, as long as it is a resin having a melting point of 140° C. or less, such as an ethylene-vinyl acetate resin.

### Electrode Layer

The electrode layer contains an electrode active material. As needed, the electrode layer contains a solid electrolyte, an electroconductive material, a binder and so on.

The electrode layer is a cathode or anode layer. Two electrode layers different in the type of the electrode active material may be prepared and used as the cathode layer and the anode layer.

As the electrode active material, any material which can be used as an active material in all-solid-state batteries, can be employed. The electrode active material may be selected from cathode and anode active materials exemplified below.

As the solid electrolyte, examples include, but are not limited to, those exemplified below in [Solid electrolyte layer].

As the electroconductive material and the binder, examples include, but are not limited to, those exemplified below in [Cathode layer].

The thickness of the electrode layer is not particularly limited. For example, it may be from 10 µm to 100 µm, or it may be from 10 µm to 20 µm.

The electrical conductivity A (mS) of the electrode layer may be from 0.008 mS to 0.03 mS, for example.

### Collector

The collector may be selected from those exemplified below as cathode and anode collectors.

### All-Solid-State Battery

The electrode of the present disclosure is an electrode for all-solid-state batteries.

The all-solid-state battery of the present disclosure may include a cathode, a solid electrolyte layer and an anode. At least one of the cathode and the anode may be the electrode of the present disclosure. Two electrodes that are composed of different kinds of electrode active materials, may be prepared and used as the cathode and the anode.

### Cathode

The cathode includes a cathode layer and a cathode collector.

### Cathode Layer

The cathode layer contains a cathode active material. As optional components, the cathode layer may contain a solid electrolyte, an electroconductive material, a binder, etc.

There is no particular limitation on the type of the cathode active material, and any material which can be used as an active material in all-solid-state batteries, can be employed. As the cathode active material, examples include, but are not limited to, lithium metal (Li), a lithium alloy, LiCoO₂, LiNi_{0.8}Co_{0.15}Al_{0.05}O₂, LiNiₓCo_{1—x}O₂ (0<x<1) , LiNi_{⅓}Co_{⅓}Mn_{⅓}O₂, LiMnO₂, a different element-substituted Li—Mn spinel, lithium titanate, lithium metal phosphate, LiCoN, Li₂SiO₃, and Li₄SiO₄, a transition metal oxide, TiS₂, Si, SiO₂, a Si alloy and a lithium storage intermetallic compound. As the different element-substituted Li-Mn spinel, examples include, but are not limited to, LiMn_{1.5}Ni_{0.5}O₄, LiMn_{1.5}Al_{0.5}O₄, LiMn_{1.5}Mg_{0.5}O₄, LiMn_{1.5}Co_{0.5}O₄, LiMn_{1.5}Fe_{0.5}O₄ and LiMn_{1.5}Zn_{0.5}O₄. As the lithium titanate, examples include, but are not limited to, Li₄Ti₅O₁₂. As the lithium metal phosphate, examples include, but are not limited to, LiFePO₄, LiMnPO₄, LiCoPO₄ and LiNiPO₄. As the transition metal oxide, examples include, but are not limited to, V₂O₅ and MoO₃. As the lithium storage intermetallic compound, examples include, but are not limited to, Mg₂Sn, Mg₂Ge, Mg₂Sb and Cu₃Sb.

As the lithium alloy, examples include, but are not limited to, Li—Au, Li—Mg, Li—Sn, Li—Si, Li—Al, Li—B, Li—C, Li—Ca, Li—Ga, Li—Ge, Li—As, Li—Se, Li—Ru, Li—Rh, Li—Pd, Li—Ag, Li—Cd, Li—In, Li—Sb, Li—Ir, Li—Pt, Li—Hg, Li—Pb, Li—Bi, Li—Zn, Li—Tl, Li—Te and Li—At. As the Si alloy, examples include, but are not limited to, an alloy of Si and a metal such as Li, and an alloy of Si and at least one kind of metal selected from the group consisting of Sn, Ge and Al.

The form of the cathode active material is not particularly limited. It may be a particulate form. When the cathode active material is in a particulate form, the cathode active material may be primary particles or secondary particles.

On the surface of the cathode active material, a coating layer containing a Li ion conductive oxide may be formed. This is because a reaction between the cathode active material and the solid electrolyte can be suppressed.

As the Li ion conductive oxide, examples include, but are not limited to, LiNbO₃, Li₄TiₛO₁₂ and Li₃PO₄. The thickness of the coating layer is, for example, 0.1 nm or more, and it may be 1 nm or more. On the other hand, the thickness of the coating layer is, for example, 100 nm or less, and it may be 20 nm or less. The coating layer may coat 70% or more of the surface of the cathode active material, or it may coat 90% or more of the surface, for example.

As the solid electrolyte, examples include, but are not limited to, those exemplified below in [Solid electrolyte layer].

The amount of the solid electrolyte contained in the cathode layer is not particularly limited. It may be within a range of, for example, from 1 mass % to 80 mass % of the total mass (100 mass %) of the cathode layer.

As the electroconductive material, a known material can be used, such as a carbon material and metal particles. As the carbon material, examples include, but are not limited to, at least one selected from the group consisting of acetylene black, furnace black, VGCF, carbon nanotube and carbon nanofiber. Among them, at least one selected from the group consisting of VGCF, carbon nanotube and carbon nanofiber may be used, from the viewpoint of electron conductivity. As the metal particles, examples include, but are not limited to, particles of Ni, Cu, Fe and SUS.

The amount of the electroconductive material contained in the cathode layer is not particularly limited.

As the binder, examples include, but are not limited to, acrylonitrile butadiene rubber (ABR), butadiene rubber (BR), polyvinylidene fluoride (PVdF) and styrene butadiene rubber (SBR). The amount of the binder contained in the cathode layer is not particularly limited.

The thickness of the cathode layer is not particularly limited. For example, the thickness may be from 10 µm to 100 µm, or it may be from 10 µm to 20 µm.

The cathode layer can be formed by a conventionally known method.

For example, the cathode active material and, as needed, other components are put in a solvent; they are stirred to prepare a cathode layer slurry; and the slurry is applied on one surface of a support; and the applied slurry is dried, thereby obtaining the cathode layer.

As the solvent, examples include, but are not limited to, butyl acetate, butyl butyrate, mesitylene, tetralin, heptane, and N-methyl-2-pyrrolidone (NMP).

The method for applying the cathode layer slurry on one surface of the support, is not particularly limited. As the method, examples include, but are not limited to, the doctor blades method, the metal mask printing method, the static coating method, the dip coating method, the spread coating method, the roll coating method, the gravure coating method, and the screen printing method.

As the support, one having self-supporting property can be appropriately selected and used without particular limitation. For example, a metal foil such as Cu and Al can be used.

As another method for forming the cathode layer, the cathode layer may be formed by pressure molding a cathode mixture powder containing the cathode active material and, as needed, other components. In the case of pressure molding the cathode mixture powder, generally, a press pressure of about 1 MPa or more and 2000 MPa or less is applied.

The method for applying the pressure is not particularly limited. As the method, examples include, but are not limited to, a pressure applying method using a plate press machine, a roll press machine, or the like.

### Cathode Collector

As the cathode collector, a known metal that can be used as a collector in all-solid-state batteries, can be employed. As the metal, examples include, but are not limited to, a metal material containing one or more elements selected from the group consisting of Cu, Ni, Al, V, Au, Pt, Mg, Fe, Ti, Co, Cr, Zn, Ge and In. As the cathode collector, examples include, but are not limited to, SUS, aluminum, nickel, iron, titanium and carbon.

The form of the cathode collector is not particularly limited. As the form, examples include, but are not limited to, various kinds of forms such as a foil form and a mesh form. The thickness of the cathode collector varies depending on the shape. For example, it may be in a range of from 1 µm to 50 µm, or it may be in a range of from 5 µm to 20 µm.

### Anode

The anode includes an anode layer and an anode collector.

### Anode Layer

The anode layer contains at least an anode active material. As needed, it contains a solid electrolyte, an electroconductive material, a binder, etc.

As the anode active material, examples include, but are not limited to, graphite, mesocarbon microbeads (MCMB), highly oriented pyrolytic graphite (HOPG), hard carbon, soft carbon, elemental lithium, a lithium alloy, elemental Si, a Si alloy and Li₄Ti₅O₁₂. As the lithium alloy and the Si alloy, those exemplified above as the cathode active material may be used.

The form of the anode active material is not particularly limited. As the form, examples include, but are not limited to, a particulate form and a plate form. When the anode active material is in a particulate form, the anode active material may be primary particles or secondary particles.

As the electroconductive material and binder used in the anode layer, those exemplified above as the electroconductive material and binder used in the cathode layer, may be used. As the solid electrolyte used in the anode layer, those exemplified below in [Solid electrolyte layer] may be used.

The thickness of the anode layer is not particularly limited. For example, it may be from 10 µm to 100 um, or it may be from 10 µm to 20 µm.

The amount of the anode active material contained in the anode layer is not particularly limited. It may be from 20 mass % to 90 mass %, for example.

### Anode Collector

The material for the anode collector may be a material that is not alloyed with Li, such as SUS, copper and nickel. As the form of the anode collector, examples include, but are not limited to, a foil form and a plate form. The plan-view shape of the anode collector is not particularly limited, and examples thereof include, but are not limited to, a circular shape, an ellipse shape, a rectangular shape and any arbitrary polygonal shape. The thickness of the anode collector varies depending on the shape. For example, it may be in a range of from 1 µm to 50 µm, or it may be in a range of from 5 µm to 20 µm.

### Solid Electrolyte Layer

The solid electrolyte layer contains at least a solid electrolyte.

As the solid electrolyte contained in the solid electrolyte layer, a conventionally-known solid electrolyte that is applicable to all-solid-state batteries can be appropriately used, such as a sulfide-based solid electrolyte, an oxide-based solid electrolyte, a hydride-based solid electrolyte, a halide-based solid electrolyte and a nitride-based solid electrolyte. The sulfide-based solid electrolyte may contain sulfur (S) as the main component of an anionic element. The oxide-based solid electrolyte may contain oxygen (O) as the main component of an anionic element. The hydride-based solid electrolyte may contain hydrogen (H) as the main component of an anionic element. The halide-based solid electrolyte may contain halogen (X) as the main component of an anionic element. The nitride-based solid electrolyte may contain nitrogen (N) as the main component of an anionic element.

The sulfide-based solid electrolyte may be a sulfide glass, a crystalline sulfide glass (glass ceramic) or a crystalline material obtained by carrying out a solid-phase reaction treatment on the raw material composition.

The crystal state of the sulfide-based solid electrolyte can be confirmed, for example, by carrying out powder X-ray diffraction measurement using CuKα rays on the sulfide-based solid electrolyte.

The sulfide glass can be obtained by carrying out an amorphous treatment on the raw material composition such as a mixture of Li₂S and P₂S₅. As the amorphous treatment, examples include, but are not limited to, mechanical milling.

The glass ceramic can be obtained, for example, by heat-treating a sulfide glass.

The heat treatment temperature may be a temperature higher than the crystallization temperature (Tc) observed by thermal analysis measurement of the sulfide glass, and it is generally 195° C. or more. On the other hand, the upper limit of the heat treatment temperature is not particularly limited. The crystallization temperature (Tc) of the sulfide glass can be measured by differential thermal analysis (DTA).

The heat treatment time is not particularly limited, as long as the desired crystallinity of the glass ceramic is obtained. For example, it is within a range of from one minute to 24 hours, and it may be within a range of from one minute to 10 hours.

The heat treatment method is not particularly limited. As the heat treatment method, examples include, but are not limited to, a heat treatment method using a firing furnace.

For example, the oxide-based solid electrolyte may be a solid electrolyte containing a Li element, a Y element (Y is at least one of Nb, B, Al, Si, P, Ti, Zr, Mo, W and S) and an O element. As the oxide-based solid electrolyte, examples include, but are not limited to, the following solid electrolytes: a garnet-type solid electrolyte such as Li₇La₃Zr₂O₁₂, Li₇₋ₓLa₃ (Zr₂₋ₓNbₓ) O₁₂ (0≤x≤2) and Li₅La₃Nb₂O₁₂; a perovskite-type solid electrolyte such as (Li, La)TiO₃, (Li, La)NbO₃ and (Li, Sr) (Ta, Zr) O₃; a nasicon-type solid electrolyte such as Li(Al, Ti) (PO₄)₃ and Li(Al, Ga) (PO₄)₃; a Li—P—O—based solid electrolyte such as Li₃PO₄ and LIPON (a compound obtained by substituting at least one “0” of Li₃PO₄ with N); and a Li—B—O—based solid electrolyte such as Li₃BO₃ and a compound obtained by substituting at least one “0” of Li₃BO₃ with C. In the present disclosure, the notation “(A, B)” in the chemical formulae means “at least one of A and B”.

For example, the hydride-based solid electrolyte contains Li and a complex anion containing hydrogen. As the complex anion, examples include, but are not limited to, (BH₄)^{—}, (NH₂)^{—}, (AlH₄)^{—} and (AlH₆)^{3—}.

As the halide-based solid electrolyte, examples include, but are not limited to, Li_{6-3z}Y_{z}X₆ (where X is at least one of Cl and Br, and z satisfies 0<z<2).

As the nitride-based solid electrolyte, examples include, but are not limited to, Li₃N.

The form of the solid electrolyte may be a particulate form, from the viewpoint of good handleability.

The average particle diameter of the solid electrolyte particles is not particularly limited. For example, the average particle diameter of the solid electrolyte particles may be 10 nm or more, or it may be 100 nm or more. On the other hand, the average particle diameter of the solid electrolyte particles may be 25 µm or less, or it may be 10 µm or less, for example.

In the present disclosure, the average particle diameter of the particles is the value of a volume-based median diameter (D50) measured by laser diffraction and scattering particle size distribution measurement, unless otherwise noted. In the present disclosure, the median diameter (D50) is a diameter (volume average diameter) such that the cumulative volume of the particles is half (50%) of the total volume when the particles are arranged in order of particle diameter from smallest to largest.

The solid electrolyte may be one kind of solid electrolyte, or it may be two or more kinds of solid electrolytes. In the case of using two or more kinds of solid electrolytes, they may be mixed together, or they may be formed into layers to obtain a multilayer structure.

The amount of the solid electrolyte in the solid electrolyte layer is not particularly limited. For example, it may be 50 mass % or more; it may be within a range of 60 mass % or more and 100 mass % or less; it may be within a range of 70 mass % or more and 100 mass % or less; or it may be 100 mass %.

A binder may also be contained in the solid electrolyte layer, from the viewpoint of expressing plasticity, etc. As the binder, examples include, but are not limited to, materials exemplified above as the binder used in the cathode layer. However, to facilitate high output, the binder contained in the solid electrolyte layer may be 5 mass % or less, from the viewpoint of preventing excessive aggregation of the solid electrolyte and enabling the formation of the solid electrolyte layer in which the solid electrolyte is uniformly dispersed.

The thickness of the solid electrolyte layer is not particularly limited. In general, it is 0.1 µm or more and 1 mm or less.

As the method for forming the solid electrolyte layer, examples include, but are not limited to, applying a solid electrolyte layer slurry containing a solid electrolyte on a support and drying the applied slurry, and pressure molding a solid electrolyte material powder containing a solid electrolyte. As the support, examples include, but are not limited to, those exemplified above in [Cathode layer]. In the case of pressure molding the solid electrolyte material powder, generally, a press pressure of about 1 MPa or more and 2000 MPa or less is applied.

The method for applying the pressure is not particularly limited. As the method, examples include, but are not limited to, the pressure applying method exemplified above in the formation of the cathode layer.

As needed, the all-solid-state battery includes an outer casing for housing a stack including the cathode collector, the cathode layer, the solid electrolyte layer, the anode layer and the anode collector in this order, a fixing member, etc.

The material for the outer casing is not particularly limited, as long as it is a material stable in electrolyte. As the material, examples include, but are not limited to, a resin such as polypropylene, polyethylene and acrylic resin.

The fixing member is not particularly limited, as long as it can apply fixing pressure to the stack in the stacking direction. As the fixing member, a known fixing member that is applicable as the fixing member of an all-solid-state battery, may be used. For example, a fixing member including two plates sandwiching both surfaces of the stack, a rod connecting the plates, a controller being connected to the rod and controlling the fixing pressure by a screw structure or the like, may be used. By the controller, the desired fixing pressure can be applied to the stack.

The fixing pressure is not particularly limited. For example, it may be 0.1 MPa or more, may be 1 MPa or more, or may be 5 MPa or more. This is because it is advantageous in that the contact between the layers is easily enhanced by increasing the fixing pressure. On the other hand, the fixing pressure may be 100 MPa or less, may be 50 MPa or less, or may be 20 MPa or less, for example. This is because, when the fixing pressure is too large, there is a possibility that high stiffness is required of the fixing member, and the size of the fixing member is increased.

The all-solid-state battery may be composed of the single stack, or the all-solid-state battery may be composed of a stack of the stacks.

The all-solid-state battery may be a primary battery, or it may be a secondary battery. Among them, the all-solid-state battery may be a secondary battery. A secondary battery is a battery which can be repeatedly charged and discharged, and it is useful as an in-vehicle battery, for example. The all-solid-state battery may be an all-solid-state lithium secondary battery or an all-solid-state lithium ion secondary battery.

As the form of the all-solid-state battery, examples include, but are not limited to, a coin form, a laminate form, a cylindrical form and a square form.

As the applications of the all-solid-state battery, examples include, but are not limited to, the power sources of vehicles such as a hybrid electric vehicle (HEV), a plug-in hybrid electric vehicle (PHEV), a battery electric vehicle (BEV), a gasoline vehicle and a diesel vehicle. Especially, the all-solid-state battery of the present disclosure may be used in the driving power supply of a hybrid electric vehicle, a plug-in hybrid electric vehicle or a battery electric vehicle. Also, the all-solid-state battery of the present disclosure may be used as the powder source of mobile objects other than vehicles, such as railroads, ships and aircrafts, or it may be used as the power source of electrical appliances such as an information processing device.

### 2. Method for Producing an All-Solid-State Battery

### 2-1. First Production Method

The first all-solid-state battery production method of the present disclosure is a method for producing an all-solid-state battery in which a first electrode layer, a solid electrolyte layer and a second electrode layer are disposed in this order; a first collector and the first electrode layer are attached by an adhesive layer; and the second electrode layer and a second collector are attached by an adhesive layer,
the method comprising:
preparing a first stack in which the first electrode layer, the solid electrolyte layer and the second electrode layer are disposed in this order,
forming an adhesive layer, which is composed of adhesive lines disposed in stripes, by applying an adhesive in stripes on a surface, which is brought into contact with the first collector, of the first electrode layer or a surface, which is brought into contact with the first electrode layer, of the first collector and on a surface, which is brought into contact with the second collector, of the second electrode layer or a surface, which is brought into contact with the second electrode layer, of the second collector, and
attaching the first electrode layer and the first collector by the adhesive layer and attaching the second electrode layer and the second collector by the adhesive layer (a collector attaching step),
wherein each of a first electrode comprising the first electrode layer and the first collector and a second electrode comprising the second electrode layer and the second collector, is the electrode described above.

In the all-solid-state battery obtained by the first production method, the first electrode layer, the solid electrolyte layer and the second electrode layer are disposed in this order; the first collector and the first electrode layer are attached by the adhesive layer; and the second electrode layer and the second collector are attached by the adhesive layer.

In the all-solid-state battery obtained by the first production method, both the first electrode including the first electrode layer and the first collector and the second electrode including the second electrode layer and the second collector, are the electrodes of the present disclosure. Of the first and second electrodes, one is the cathode, and the other is the anode. The first electrode layer is the cathode layer when the first electrode is the cathode, and the first electrode layer is the anode layer when the first electrode is the anode. The second electrode layer is the cathode layer when the second electrode is the cathode, and the second electrode layer is the anode layer when the second electrode is the anode. The first collector is the cathode collector when the first electrode is the cathode, and the first collector is the anode collector when the first electrode is the anode. The second collector is the cathode collector when the second electrode is the cathode, and the second collector is the anode collector when the second electrode is the anode.

The first production method includes (1) the first stack preparing step, (2) the adhesive layer forming step and (3) the collector attaching step. The order of (1) the first stack preparing step and (2) the adhesive layer forming step is not particularly limited.

### First Stack Preparing Step

The first stack preparing step is the step of preparing the first stack in which the first electrode layer, the solid electrolyte layer and the second electrode layer are disposed in this order.

The first stack may be prepared by the following method, for example. First, a first electrode layer slurry is applied onto a support, and the applied slurry is dried to form the first electrode layer. A second electrode layer slurry is applied onto another support, and the applied slurry is dried to form the second electrode layer. Next, the solid electrolyte layer is prepared. The first electrode layer is disposed on one surface of the solid electrolyte layer, and the support of the first electrode layer is removed therefrom. The second electrode layer is disposed on the other surface of the solid electrolyte layer, and the support of the second electrode layer is removed therefrom. Accordingly, the first stack is obtained.

### Adhesive Layer Forming Step

The adhesive layer forming step is the step of forming the adhesive layer, which is composed of the adhesive lines disposed in stripes, by applying the adhesive in stripes on the surface, which is brought into contact with the first collector, of the first electrode layer or the surface, which is brought into contact with the first electrode layer, of the first collector and on the surface, which is brought into contact with the second collector, of the second electrode layer or the surface, which is brought into contact with the second electrode layer, of the second collector.

As the adhesive used to form the adhesive layer, examples include, but are not limited to, the same materials as those described above in “1. Electrode″.

### Collector Attaching Step

The collector attaching step is the step of attaching the first electrode layer and the first collector by the adhesive layer and attaching the second electrode layer and the second collector by the adhesive layer.

The attaching method is not particularly limited. As the attaching method, examples include, but are not limited to, applying press pressure to a stack including the first electrode layer, the first collector, the second electrode layer and the second collector, and heat-pressing a stack including the first electrode layer, the first collector, the second electrode layer and the second collector. In the case of heat-pressing the stack, the heating temperature may be 140° C. or more, for example. The press pressure may be 1 MPa or more, for example.

### 2-2. Second Production Method

The second all-solid-state battery production method of the present disclosure is a method for producing an all-solid-state battery in which a first electrode layer, a solid electrolyte layer and a second electrode layer are disposed in this order on both surfaces of a first collector, and the second electrode layer and a second collector are attached by an adhesive layer,
the method comprising:
preparing a second stack in which the first electrode layer, the solid electrolyte layer and the second electrode layer are disposed in this order on both surfaces of the first collector;
forming an adhesive layer, which is composed of adhesive lines disposed in stripes, by applying an adhesive in stripes on a surface, which is brought into contact with the second collector, of the second electrode layer or a surface, which is brought into contact with the second electrode layer, of the second collector, and
attaching the second electrode layer and the second collector by the adhesive layer (a collector attaching step),
wherein a second electrode comprising the second electrode layer and the second collector is the electrode described above.

In the all-solid-state battery obtained by the second production method, the first electrode layer, the solid electrolyte layer and the second electrode layer are disposed in this order on both surfaces of the first collector, and the second electrode layer and the second collector are attached by the adhesive layer.

In the all-solid-state battery obtained by the second production method, the second electrode including the second electrode layer and the second collector is the electrode of the present disclosure. Of the first and second electrodes, one is the cathode, and the other is the anode. The first electrode layer is the cathode layer when the first electrode is the cathode, and the first electrode layer is the anode layer when the first electrode is the anode. The second electrode layer is the cathode layer when the second electrode is the cathode, and the second electrode layer is the anode layer when the second electrode is the anode. The first collector is the cathode collector when the first electrode is the cathode, and the first collector is the anode collector when the first electrode is the anode. The second collector is the cathode collector when the second electrode is the cathode, and the second collector is the anode collector when the second electrode is the anode.

The second production method includes (A) the second stack preparing step, (B) the adhesive layer forming step and (C) the collector attaching step. The order of (A) the second stack preparing step and (B) the adhesive layer forming step is not particularly limited.

### (A) Second Stack Preparing Step

The second stack preparing step is the step of preparing the second stack in which the first electrode layer, the solid electrolyte layer and the second electrode layer are disposed in this order on both surfaces of the first collector.

The second stack may be prepared by the following method, for example. First, a first electrode layer slurry is applied onto both surfaces of the first collector, and the applied slurry is dried to form the first electrode layers. Next, the solid electrolyte layer is disposed on each of the first electrode layers. A second electrode layer slurry is applied onto two supports, and the applied slurry is dried to form the second electrode layers. Each second electrode layer is disposed on one surface, which is opposite to the surface on which the first electrode layer is formed, of each solid electrolyte layer. Then, the support of each second electrode layer is removed therefrom. Accordingly, the second stack is obtained.

### (B) Adhesive Layer Forming Step

The adhesive layer forming step is the step of forming the adhesive layer, which is composed of the adhesive lines disposed in stripes, by applying the adhesive in stripes on the surface, which is brought into contact with the second collector, of the second electrode layer or the surface, which is brought into contact with the second electrode layer, of the second collector.

As the adhesive used to form the adhesive layer, examples include, but are not limited to, the same materials as those described above in “1. Electrode″.

### (C) Collector Attaching Step

The collector attaching step is the step of attaching the second electrode layer and the second collector by the adhesive layer.

As the attaching method, examples include, but are not limited to, the same methods as those exemplified above in “2-1. First production method”.

### EXAMPLES

### Example 1

### Production of Cathode Layer

In the air atmosphere, cathode active material particles (particles in which Li_{1.15}Ni_{⅓}Co_{⅓}Mn_{⅓}O₂ is the main phase) were coated with lithium niobate by use of a tumbling/fluidizing coater (manufactured by Powrex Corporation). The coated particles were fired in the air atmosphere, thereby obtaining cathode active material particles having a lithium niobate coating layer.

Next, PVdF, the cathode active material particles, a sulfide-based solid electrolyte (Li₂S-P₂S₅-based glass ceramic) and VGCF (manufactured by Showa Denko K. K.) were added in a polypropylene container to obtain a cathode layer slurry. The slurry was stirred for 30 seconds by an ultrasonic disperser (product name: UH-50, manufactured by: SMT Co., Ltd.)

Next, the polypropylene container was shaken for 3 minutes by a shaking device (product name: TTM-1, manufactured by: Sibata Scientific Technology Ltd.) The cathode layer slurry was further stirred for 30 seconds by the ultrasonic disperser. After the container was shaken for 3 minutes by the shaking device, the cathode layer slurry was applied on an aluminum foil, which served as a substrate, by the blade method using an applicator. Then, the applied cathode layer slurry was naturally dried. The naturally dried slurry was dried on a hot plate at 100° C. for 30 minutes to form a cathode mixture on the aluminum foil, thereby obtaining a stack of the aluminum foil and the cathode mixture. The stack was pressed at 4 t/cm to form a cathode layer on the aluminum foil. The amount of the applied cathode layer slurry was controlled so that the thickness of the cathode layer obtained by pressing the cathode mixture at 4 t/cm, was 15 µm.

### Production of Anode

First, PVdF, anode active material particles (Li₄Ti₅O₁₂ (LTO) particles) and the same sulfide-based solid electrolyte as above (Li₂S-P₂S₅-based glass ceramic) were added in a polypropylene container to obtain an anode layer slurry. The slurry was stirred for 30 minutes by the ultrasonic disperser. The anode layer slurry was applied on a copper foil, which served as an anode collector, by the blade method using an applicator. Then, the applied anode layer slurry was naturally dried. The naturally dried slurry was dried on a hot plate at 100° C. for 30 minutes, thereby obtaining an anode in which an anode layer was formed on the copper foil. Then, the anode layer slurry was applied on the rear surface of the copper foil as described above, and the applied anode layer slurry was dried as described above, thereby forming an anode layer on the rear surface of the copper foil

### Production of Solid Electrolyte Layer

First, heptane, BR and a sulfide-based solid electrolyte (Li₂S-P₂S₅-based glass ceramic) were added in a polypropylene container to obtain a solid electrolyte layer slurry. The slurry was stirred for 30 seconds by the ultrasonic disperser. Next, the polypropylene container was shaken for 30 minutes by the shaking device (product name: TTM-1, manufactured by: Sibata Scientific Technology Ltd.) The solid electrolyte layer slurry was further stirred for 30 seconds by the ultrasonic disperser. After the container was shaken for 3 minutes by the shaking device, the solid electrolyte layer slurry was applied on an aluminum foil, which served as a substrate, by the blade method using an applicator. Then, the applied solid electrolyte layer slurry was naturally dried. The naturally dried slurry was dried on a hot plate at 100° C. for 30 minutes to form a solid electrolyte layer on the aluminum foil.

### Production of Carbon-coated Aluminum Foil (Cathode Collector)

First, furnace black (an electroconductive material ) and PVdF (a binder) were weighed in a ratio of 25:75 (vol. %) . Then, NMP was mixed with them to produce a carbon coating composition. Next, the carbon coating composition was applied to one surface of an aluminum foil to a thickness of 2 µm. The applied carbon coating composition was dried at 100° C. for one hour, thereby producing a carbon-coated aluminum foil. The carbon-coated aluminum foil was cut so that the size of the aluminum foil was 69.0 mm × 73.0 mm and the size of the carbon coating was 69.0 mm × 71.0 mm.

### (B) Adhesive Layer Forming Step

Next, as an adhesive, a hot-melt agent (product name: HI-BON ZH234-1, manufactured by Hitachi Chemical Co., Ltd.) was applied in stripes to one surface of the carbon-coated aluminum foil so that the width B of the applied adhesive lines was 0.8 mm and the pitch of the adhesive lines (the distance C between the adjacent adhesive lines) was 0.4 mm, thereby forming an adhesive layer.

### (A) Second Stack Preparing Step

### Production of Second Stack

The solid electrolyte layers were attached to both surfaces of the anode so that each solid electrolyte layer was in direct contact with each anode layer. They were pressed at 1.6 t/cm. Next, the aluminum foil (the substrate) of each solid electrolyte layer was removed therefrom. Next, the cathode layer was attached to each solid electrolyte layer so that the cathode layer was in direct contact with the solid electrolyte layer. They were pressed at 1.6 t/cm. Next, the aluminum foil (the substrate) of each cathode layer was removed therefrom to obtain the second stack, and the second stack was pressed at 5 t/cm. Next, the second stack was trimmed with laser so that the size of each cathode layer was 70.0 mm × 70.0 mm. Then, the trimmed second stack was cut so that the size of the anode was 72.0 mm × 72.0 mm.

Next, terminals were welded to the second stack.

### (C) Collector Attaching Step

On both surfaces of the second stack, the carbon-coated aluminum foils (the cathode collectors) were positioned and disposed in a region 2.0 mm away from the end of the anode so that each cathode layer and each carbon-coated aluminum foil (the cathode collector) were attached via the adhesive layer. While applying a pressure of 1 MPa, they are heated to 140° C. to attach each cathode layer and each carbon-coated aluminum foil (the cathode collector). An electrode cell thus obtained was vacuum-encapsulated in a laminate outer casing, thereby obtaining an all-solid-state battery.

Then, the all-solid-state battery was fixed at 5 MPa and kept at 80° C. for 80 hours.

### Electrical Conductivity Evaluation Method

The method for measuring the electrical conductivity (mS/cm) of the cathode mixture, is as follows.

Two stacks were prepared, each of which is the stack of the aluminum foil (the substrate) and the cathode mixture obtained in [Production of cathode layer]. The stacks were attached so that their cathode mixtures were attached to each other, thereby obtaining an assembly. The assembly was pressed at 4 t/cm and then cut in a size with a diameter of 11.28 mm, thereby obtaining a sample. The resistance between the two aluminum foils of the sample was measured. The electrical conductivity (mS/cm) of the cathode mixture was obtained by the following formula. As a result, the electrical conductivity (mS/cm) of the cathode mixture was 8 mS/cm. The result is shown in Table 1.

The electrical conductivity (mS/cm) of the cathode mixture = The thickness of the sample / The cross-sectional area of the sample / The resistance of the sample

The electrical conductivity A (mS) of the cathode layer was obtained by the following formula. As a result, the electrical conductivity A (mS) of the cathode layer was 0.012 mS. The result is shown in Table 1.

The electrical conductivity A (mS) of the cathode layer = The electrical conductivity (mS/cm) of the cathode mixture * The thickness (cm) of the cathode layer

The ratio (B/A) of the width B (mm) of the applied adhesive lines to the electrical conductivity A (mS) of the cathode layer, was 66.67.

The ratio (B/C) of the width B of the applied adhesive lines to the distance C between the adjacent adhesive lines, was 2.00.

### Comparative Example 1

An all-solid-state battery was obtained in the same manner as Example 1, except that in (B) the adhesive layer forming step, the adhesive was applied in the shape of the letter “L” along the sides near the four corners of one surface of the carbon-coated aluminum foil.

### Examples 2 to 5 and Comparative Examples 2 and 3

An all-solid-state battery was obtained in the same manner as Example 1, except that in (B) the adhesive layer forming step, the distance C between the adjacent adhesive lines was changed to 0.2 mm in Comparative Example 2, 0.8 mm in Example 2, 3 mm in Example 3, 5 mm in Example 4, 7 mm in Example 5, and 9 mm in Comparative Example 3.

The ratio (B/A) of the width B (mm) of the applied adhesive lines to the electrical conductivity A (mS) of the cathode layer, was 66.67 in Examples 2 to 5 and Comparative Examples 2 and 3.

The ratio (B/C) of the width B of the applied adhesive lines to the distance C between the adjacent adhesive lines, was 4.00 in Comparative Example 2, 1.00 in Example 2, 0.27 in Example 3, 0.16 in Example 4, 0.11 in Example 5, and 0.09 in Comparative Example 3.

### Comparative Example 4

An all-solid-state battery was obtained in the same manner as Example 1, except that in (B) the adhesive layer forming step, the width B of the applied adhesive lines was changed to 1.2 mm, and the distance C between the adjacent adhesive lines was changed to 3 mm.

The ratio (B/A) of the width B (mm) of the applied adhesive lines to the electrical conductivity A (mS) of the cathode layer, was 100.00.

The ratio (B/C) of the width B of the applied adhesive lines to the distance C between the adjacent adhesive lines, was 0.40.

### Comparative Example 5

An all-solid-state battery was obtained in the same manner as Example 1, except that in (B) the adhesive layer forming step, the width B of the applied adhesive lines was changed to 1.6 mm; the distance C between the adjacent adhesive lines was changed to 3 mm; the electrical conductivity of the cathode mixture was changed to 12 mS/cm; and the electrical conductivity A (mS) of the cathode layer was changed to 0.018 mS. The electrical conductivity (mS/cm) of the cathode mixture was changed by controlling the amount of the VGCF contained in the cathode mixture.

The ratio (B/A) of the width B (mm) of the applied adhesive lines to the electrical conductivity A (mS) of the cathode layer, was 88.89.

The ratio (B/C) of the width B of the applied adhesive lines to the distance C between the adjacent adhesive lines, was 0.53.

### Example 6

An all-solid-state battery was obtained in the same manner as Example 1, except that in (B) the adhesive layer forming step, the width B of the applied adhesive lines was changed to 1.2 mm; the distance C between the adjacent adhesive lines was changed to 3 mm; the electrical conductivity of the cathode mixture was changed to 12 mS/cm; and the electrical conductivity A (mS) of the cathode layer was changed to 0.018 mS. The electrical conductivity (mS/cm) of the cathode mixture was changed by controlling the amount of the VGCF contained in the cathode mixture.

The ratio (B/A) of the width B (mm) of the applied adhesive lines to the electrical conductivity A (mS) of the cathode layer, was 66.67.

The ratio (B/C) of the width B of the applied adhesive lines to the distance C between the adjacent adhesive lines, was 0.40.

### Example 7

An all-solid-state battery was obtained in the same manner as Example 1, except that in (B) the adhesive layer forming step, the width B of the applied adhesive lines was changed to 1.6 mm; the distance C between the adjacent adhesive lines was changed to 3 mm; the electrical conductivity of the cathode mixture was changed to 20 mS/cm; and the electrical conductivity A (mS) of the cathode layer was changed to 0.030 mS. The electrical conductivity (mS/cm) of the cathode mixture was changed by controlling the amount of the VGCF contained in the cathode mixture.

The ratio (B/A) of the width B (mm) of the applied adhesive lines to the electrical conductivity A (mS) of the cathode layer, was 53.33.

The ratio (B/C) of the width B of the applied adhesive lines to the distance C between the adjacent adhesive lines, was 0.53.

### Example 8

An all-solid-state battery was obtained in the same manner as Example 1, except that in (B) the adhesive layer forming step, the width B of the applied adhesive lines was changed to 1.2 mm; the distance C between the adjacent adhesive lines was changed to 3 mm; the thickness of the cathode layer was changed to 20 µm; and the electrical conductivity A (mS) of the cathode layer was changed to 0.016 mS. The thickness of the cathode layer was changed by controlling the amount of the cathode layer slurry applied to the substrate.

The ratio (B/A) of the width B (mm) of the applied adhesive lines to the electrical conductivity A (mS) of the cathode layer, was 75.00.

The ratio (B/C) of the width B of the applied adhesive lines to the distance C between the adjacent adhesive lines, was 0.40.

### Comparative Example 6

An all-solid-state battery was obtained in the same manner as Example 1, except that in (B) the adhesive layer forming step, the distance C between the adjacent adhesive lines was changed to 3 mm; the thickness of the cathode layer was changed to 10 µm; and the electrical conductivity A (mS) of the cathode layer was changed to 0.008 mS. The thickness of the cathode layer was changed by controlling the amount of the cathode layer slurry applied to the substrate.

The ratio (B/A) of the width B (mm) of the applied adhesive lines to the electrical conductivity A (mS) of the cathode layer, was 100.00.

The ratio (B/C) of the width B of the applied adhesive lines to the distance C between the adjacent adhesive lines, was 0.27.

### Example 9

An all-solid-state battery was obtained in the same manner as Example 1, except that in (B) the adhesive layer forming step, the width B of the applied adhesive lines was changed to 0.6 mm; the distance C between the adjacent adhesive lines was changed to 3 mm; the thickness of the cathode layer was changed to 10 µm; and the electrical conductivity A (mS) of the cathode layer was changed to 0.008 mS. The thickness of the cathode layer was changed by controlling the amount of the cathode layer slurry applied to the substrate.

The ratio (B/A) of the width B (mm) of the applied adhesive lines to the electrical conductivity A (mS) of the cathode layer, was 75.00.

The ratio (B/C) of the width B of the applied adhesive lines to the distance C between the adjacent adhesive lines, was 0.20.

### Example 10

An all-solid-state battery was obtained in the same manner as Example 1, except that in (B) the adhesive layer forming step, the distance C between the adjacent adhesive lines was changed to 3 mm; the thickness of the cathode layer was changed to 10 µm; the electrical conductivity of the cathode mixture was changed to 12 mS/cm; and the electrical conductivity A (mS) of the cathode layer was changed to 0.012 mS. The thickness of the cathode layer was changed by controlling the amount of the cathode layer slurry applied to the substrate. The electrical conductivity (mS/cm) of the cathode mixture was changed by controlling the amount of the VGCF contained in the cathode mixture.

The ratio (B/A) of the width B (mm) of the applied adhesive lines to the electrical conductivity A (mS) of the cathode layer, was 66.67.

The ratio (B/C) of the width B of the applied adhesive lines to the distance C between the adjacent adhesive lines, was 0.27.

### Resistance Evaluation Method

Each all-solid-state battery was charged with constant current and constant voltage (CCCV) at an upper limit voltage of 2.95 V and a rate of 1 C (cut current 0.01 C) . Then, the battery was discharged with CCCV at a lower limit voltage of 1.50 V and a rate of 1 C (cut current 0.01 C).

The voltage of the all-solid-state battery was set to 2.36 V. The all-solid-state battery was charged with constant current (CC) at a rate of 2 C for 10 seconds (s) . From the amount of change in voltage, the resistance of the all-solid-state battery was calculated. The results are shown in Tables 1 and 2.

TABLE 1

| | Comparative Example 1 | Comparative Example 2 | Example 1 | Example 2 | Example 3 | Example 4 | Example 5 | Comparative Example 3 |
|---|---|---|---|---|---|---|---|---|
| Width B (mm) of adhesive lines | 0.8 | 0.8 | 0.8 | 0.8 | 0.8 | 0.8 | 0.8 | 0.8 |
| Distance C (mm) between adhesive lines | - | 0.2 | 0.4 | 0.8 | 3 | 5 | 7 | 9 |
| Shape of adhesive lines | The letter “L” | Stripes | Stripes | Stripes | Stripes | Stripes | Stripes | Stripes |
| Electrical conductivity (mS/cm) of cathode mixture | 8 | 8 | 8 | 8 | 8 | 8 | 8 | 8 |
| Thickness (µm) of cathode layer | 15 | 15 | 15 | 15 | 15 | 15 | 15 | 15 |
| Length (mm) of adhesive lines | 7 | 7 | 7 | 7 | 7 | 7 | 7 | 7 |
| Electrical conductivity A (mS) of cathode layer | 0.012 | 0.012 | 0.012 | 0.012 | 0.012 | 0.012 | 0.012 | 0.012 |
| B/A | 66.67 | 66.67 | 66.67 | 66.67 | 66.67 | 66.67 | 66.67 | 66.67 |
| B/C | - | 4.00 | 2.00 | 1.00 | 0.27 | 0.16 | 0.11 | 0.09 |
| Resistance (Ω/cm²) | 12.00 | 12.10 | 11.26 | 10.84 | 10.53 | 10.60 | 11.50 | 12.50 |

TABLE 2

| | Comparative Example 4 | Comparative Example 5 | Example 6 | Example 7 | Example 8 | Comparative Example 6 | Example 9 | Example 10 |
|---|---|---|---|---|---|---|---|---|
| Width B (mm) of adhesive lines | 1.2 | 1.6 | 1.2 | 1.6 | 1.2 | 0.8 | 0.6 | 0.8 |
| Distance C (mm) between adhesive lines | 3 | 3 | 3 | 3 | 3 | 3 | 3 | 3 |
| Shape of adhesive lines | Stripes | Stripes | Stripes | Stripes | Stripes | Stripes | Stripes | Stripes |
| Electrical conductivity | 8 | 12 | 12 | 20 | 8 | 8 | 8 | 12 |
| (mS/cm) of cathode mixture | | | | | | | | |
| Thickness (µm) of cathode layer | 15 | 15 | 15 | 15 | 20 | 10 | 10 | 10 |
| Length (mm) of adhesive lines | 7 | 7 | 7 | 7 | 7 | 7 | 7 | 7 |
| Electrical conductivity A (mS) of cathode layer | 0.012 | 0.018 | 0.018 | 0.030 | 0.016 | 0.008 | 0.008 | 0.012 |
| B/A | 100.00 | 88.89 | 66.67 | 53.33 | 75.00 | 100.00 | 75.00 | 66.67 |
| B/C | 0.40 | 0.53 | 0.40 | 0.53 | 0.40 | 0.27 | 0.20 | 0.27 |
| Resistance (Ω/cm²) | 13.59 | 12.65 | 10.55 | 10.65 | 10.56 | 12.53 | 11.50 | 10.53 |

### Evaluation Results

As shown in Tables 1 and 2, the resistances of the all-solid-state batteries of Examples 1 to 10 are lower than the resistances of the all-solid-state batteries of Comparative Examples 1 to 6.

In Comparative Example 1, which is the prior art, the adhesive was not applied to the entire contact surface of the collector and that of the electrode layer. Accordingly, except for seal pressure, there was no enough force to attach the collector and the electrode layer. Accordingly, the resistance of the all-solid-state battery increased.

In Examples 1 to 10, the collector and the electrode layer were sufficiently attached by the adhesive, and the resistance of the all-solid-state battery decreased.

In the case where the ratio (B/A) of the width B (mm) of the applied adhesive lines to the electrical conductivity A (mS) of the cathode layer, was more than 75.00, it is thought that the electrical conductivity A (mS) of the cathode layer was not sufficient, and due to a decrease in reaction effective area, the resistance of the all-solid-state battery increased in Comparative Examples 4 to 6.

In the case where the distance C (mm) between the adjacent adhesive lines was more than 7 mm, it is thought that the force of attaching the collector and the electrode layer by the adhesive was not sufficient, and the resistance of the all-solid-state battery increased in Comparative Example 3.

In the case where the ratio (B/C) of the width B of the applied adhesive lines to the distance C between the adjacent adhesive lines, was more than 2, it is thought that the contact area between the collector and the electrode layer were not sufficient, and the resistance of the all-solid-state battery increased in Comparative Example 2.

### REFERENCE SIGNS LIST

11. Collector
12. Electrode layer
13. Adhesive line
B. Width of adhesive line
C. Distance between adjacent adhesive lines

1. An electrode for all-solid-state batteries, the electrode comprising a collector and an electrode layer,
wherein a contact surface of the collector with the electrode layer and a contact surface of the electrode layer with the collector, are attached by an adhesive layer;
wherein the adhesive layer is composed of adhesive lines disposed in stripes between the contact surfaces;
wherein a ratio (B/A) of a width B (mm) of the applied adhesive lines to an electrical conductivity A (mS) of the electrode layer, is 75.00 or less;
wherein a distance C (mm) between the adjacent adhesive lines is more than 0.2 mm and is 7 mm or less; and
wherein a ratio (B/C) of the width B of the applied adhesive lines to the distance C between the adjacent adhesive lines, is 2.00 or less.

2. A method for producing an all-solid-state battery in which a first electrode layer, a solid electrolyte layer and a second electrode layer are disposed in this order; a first collector and the first electrode layer are attached by an adhesive layer; and the second electrode layer and a second collector are attached by an adhesive layer,
the method comprising:
preparing a first stack in which the first electrode layer, the solid electrolyte layer and the second electrode layer are disposed in this order,
forming an adhesive layer, which is composed of adhesive lines disposed in stripes, by applying an adhesive in stripes on a surface, which is brought into contact with the first collector, of the first electrode layer or a surface, which is brought into contact with the first electrode layer, of the first collector and on a surface, which is brought into contact with the second collector, of the second electrode layer or a surface, which is brought into contact with the second electrode layer, of the second collector, and
attaching the first electrode layer and the first collector by the adhesive layer and attaching the second electrode layer and the second collector by the adhesive layer (a collector attaching step),
wherein each of a first electrode comprising the first electrode layer and the first collector and a second electrode comprising the second electrode layer and the second collector, is the electrode defined by claim 1.

3. A method for producing an all-solid-state battery in which a first electrode layer, a solid electrolyte layer and a second electrode layer are disposed in this order on both surfaces of a first collector, and the second electrode layer and a second collector are attached by an adhesive layer,
the method comprising:
preparing a second stack in which the first electrode layer, the solid electrolyte layer and the second electrode layer are disposed in this order on both surfaces of the first collector;
forming an adhesive layer, which is composed of adhesive lines disposed in stripes, by applying an adhesive in stripes on a surface, which is brought into contact with the second collector, of the second electrode layer or a surface, which is brought into contact with the second electrode layer, of the second collector, and
attaching the second electrode layer and the second collector by the adhesive layer (a collector attaching step),
wherein a second electrode comprising the second electrode layer and the second collector is the electrode defined by claim 1.
